(19) United States
(12) Patent Application Publication
(10) Pub. No.: US 2002/0114279 A1
(43) Pub. Date: Aug. 22, 2002

(54) Telecommunications systems

(76) Inventor: Ann-Christine Eriksson, Sundbyberg (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/041,581

(22) Filed: Jan. 10, 2002

(30) Foreign Application Priority Data
Jan. 11, 2001 (GB) 0100789.7

(51) Int. Cl. H04J 1/16; H04J 3/16

(52) U.S. Cl. 370/235; 370/465

(57) ABSTRACT

A method is disclosed for controlling data flow in a telecommunications network in which a base station communicates with a mobile station using a plurality of packet data flows, the packet data flows having respective data flow rates. The method comprises controlling data flow through the network by controlling the data flow rate of each packet data flow, an overall data flow rate to the mobile station and a data flow rate for each base station.

The present invention relates to telecommunications systems, and in particular to digital mobile telephone systems.

### BACKGROUND OF THE INVENTION

In a GPRS (General Packet Radio System) network a mobile station (MS) may have several packet data flows running at the same time. Each flow is known as a packet data protocol (PDP) context. Typically one PDP context would be run per application type or per destination. The packet data flows may have different quality of service (QoS) levels and different destination points. In data flows between the serving GPRS support node (SGSN) and the base station system (BSS), two or more PDP contexts may be grouped together to form a packet flow context (PFC) if they are of similar QoS. The similar QoS profiles for the PDP contexts that form a PFC are grouped into an aggregate QoS profile. In the BSS, the PFC is treated as one flow and no knowledge of the individual PDP context is available. If the MS has several PDP contexts with different QoS, there will be several PFC's to the same MS. For each packet data flow the QoS profile specifies the priority, guaranteed bit rate, guaranteed delay etc. The attributes in the QoS per PDP context are used when scheduling the MS in the SGSN. In the BSS the aggregate QoS for a PFC is used to schedule the MS on the radio interface.

The data flow between the SGSN and the BSS is controlled per BVCI (BSSGP virtual connection identifier) and per MS with a flow control mechanism. The rate of the data flow through the BSS from the SGSN is determined by the transmission rate on the radio interface to each MS.

The current GSM standard gives possibilities to control the data flow between the SGSN and the BSS per BVCI and per MS. An MS may have data flows running for several PFC's at the same time. The sum of these data flows to one MS is controlled with the flow control mechanism.

However, when the data flow to the BSS is only controlled per MS and per BVCI, the BSS has no possibility to inform the SGSN to increase or decrease the rate of data flow per PFC. This causes congestion for mobile stations with data flows of different QoS. The reason for this is that the MS buffers in the BSS may be filled with data for flows with low priority or low guaranteed bit rate and delay. The BSS then notifies the SGSN to decrease or to stop the data flow for this MS. Thus the SGSN cannot send new data for this MS to the BSS even if the data has high priority or high demands on throughput and delay.

More information concerning the current solution can be found in 3GPP TS 08.18v.8.7.0.

### SUMMARY OF THE PRESENT INVENTION

An object of the present invention is to introduce an extended and improved flow control mechanism, which is more flexible than the prior art flow control mechanisms in mobile communications systems having a packet data transmission capability.

Another object of the present invention is a flow control mechanism that provides support for the QoS requirements in mobile communications systems having a packet data transmission capability.

According to the present invention, the data flow is controlled per packet data flow defined by an aggregate QoS profile in addition to being controlled per MS and per cell identity The data flow may then be increased or decreased depending on the aggregate QoS of the packet data flows for a mobile station. An MS may have several packet data flows with respective aggregate QoS. For an MS, the data flow may be increased for a packet flow having an aggregate QoS with high priority or high requirements on throughput or delay. At the same time, the data flow may be decreased for a packet data flow having an aggregate QoS with low priority or low requirements on throughput and delay for the same MS.

It is emphasised that the term “comprises” or “comprising” is used in this specification to specify the presence of stated features, integers, steps or components, but does not preclude the addition of one or more further features, integers, steps or components, or groups thereof.

### BRIEF DESCRIPTION OF THE DRAWINGS

FIG. 1 is a schematic drawing illustrating data flows in a GPRS mobile telephone network;

FIG. 2 illustrates flow control buffers; and

FIG. 3 illustrates flow control in a GPRS mobile telephone system.

### DETAILED DESCRIPTION OF THE PREFERRED EMBODIMENT

A solution to overcome the problem of data flow control in a GPRS network is to control data flow per packet flow context of a mobile station in addition to controlling the flow per mobile station and per BVCI. The base station system can then control the data flow with greater regard to the particular circumstances of each context. For example, the BSS may decrease the data flow with low priority or low guaranteed bit rate and delay and at the same time increase the data flow with high priority or high guarantee bit rate and delay for the same mobile station.

In the BSS there are several PFC's stored, one for each aggregate QoS per MS. Some PFC's may be of the same type—Conversational, Streaming, interactive or Background. The BSS shall control the data flow from the SGSN per BVCI and per MS, and also per PFC or per PFC type of a MS. If one MS has several PFC's of the same type, the data flow to these PFC's may be controlled together.

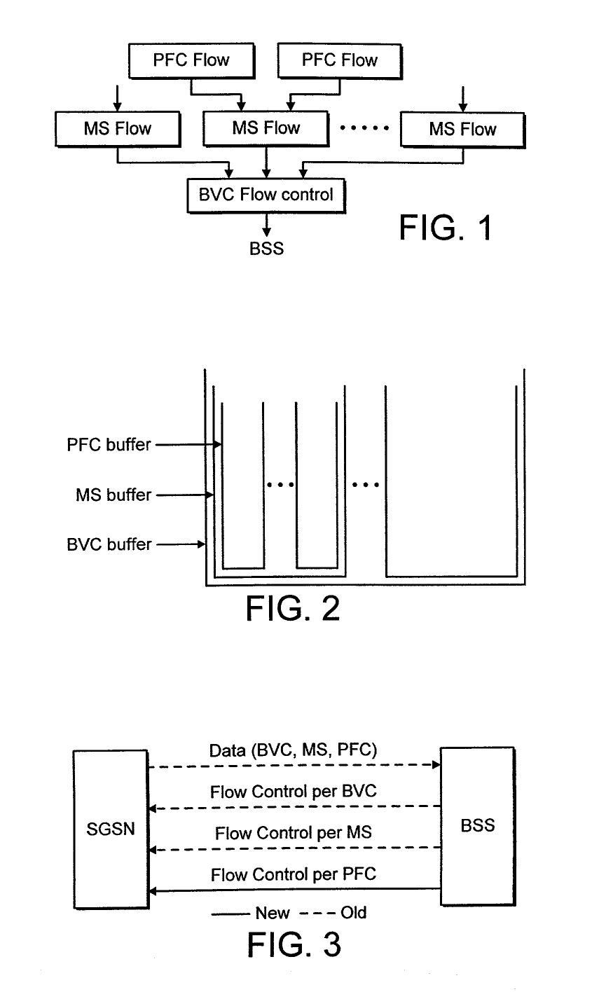

FIG. 1 illustrates flow control per BVCI, individual MS and individual PFC per MS. The flow control mechanism conforms to a leaky bucket algorithm. The bucket has a size, a bucket full ratio and a leak rate. The leak rate corresponds to the rate at which the data flows on the radio interface in a cell.

In the BSS the bucket consists of a buffer for every BVCI, individual MS and also for every individual PFC per MS, see FIG. 2. The BSS controls the data flow from the SGSN to the BSS by indicating the bucket size, the leak rate of the bucket and the bucket full ratio per BVC, per individual MS and also per individual PFC of a MS.

FIG. 2 illustrates the buffers in the BSS for which flow control is applied.

The buffers in the BSS are filled with data sent by the SGSN. The BSS empties the buffers according to the QoS for each PFC and MS. With the addition of flow control per PFC, the SGSN gets information about how much data each PFC buffer of a MS contains. Without this information the SGSN would not know what type of data each MS buffer contains. With flow control also per PFC both the SGSN and the BSS get better control of the data flows in a BVC and they are able to promote data flows with high priority or high demands on bitrate and delay.

When an MS buffer is almost full the data flow for one PFC of that MS may be decreased, while the other data flows are maintained. Thus giving the possibility to limit the data flow for low priority PFC's or PFC's with low bitrate and delay requirements. For example, the data flow for a Background PFC may be decreased or even stopped in order to be able to fulfil the guaranteed bitrate and delay for a data flow of Streaming PFC.

FIG. 3 illustrates Flow Control in a GPRS system.

Data for a specific PFC belonging to an MS that is located in a BVC is sent from the SGSN to the BSS. The BSS may control the data flow per BVCI, individual MS and also per individual PFC for an MS. The additional flow control indication per PFC for each mobile station may for example be included in one of the existing flow control messages per BVCI or per MS, or it may construct a new message that is sent between the BSS and the SGSN. The PFC flow control information may consist of for example PFC bucket size, PFC bucket leak rate and PFC bucket full ratio. PFC's of the same type to one mobile station may be controlled together.

The embodiment of the present invention makes it possible to differentiate data flows with different quality of service levels for the same mobile station. Each data flow for each mobile station is treated separately according to its quality of service in the BSS.

1. A method of controlling data flow in a telecommunications network in which a base station communicates with a mobile station using a plurality of packet data flows, the packet data flows having respective data flow rates, wherein the method comprises controlling data flow through the network by controlling the data flow rate of each packet data flow, an overall data flow rate to the mobile station and a data flow rate for each base station.

2. A method as claimed in claim 1, wherein the packet data flow is controlled in dependence upon a quality of service level associated therewith.

3. A method as claimed in claim 1, wherein the packet data flows are channelled through respective buffers which are operable to receive, store and output data from the associated packet data flows, the packet data flows being controlled such that data output from the buffers is dependant upon the quality of service level for the packet data flow concerned.

4. A method as claimed in claim 1, wherein the packet data flows are packet flow contexts (PFCs).

5. A method as claimed in claim 4, wherein the data flow for a base station is a BVCI connection (BSSGP virtual connection identifier).

6. A method as claimed in claim 1, wherein the network is a GPRS network.

7. A telecommunications network comprising a base station which is operable to communicate with a mobile station using a plurality of packet data flows associated with the mobile station, each packet data flow having a data flow rate, wherein the base station is operable to control data flow to a mobile station by controlling the data flow rates of the packet data flows associated with the mobile station concerned.

8. A network as claimed in claim 7, wherein the packet data flow is controlled in dependence upon a quality of service level associated therewith.

9. A network as claimed in claim 7 wherein the packet data flows are channelled through respective buffers which are operable to receive, store and output data from the associated packet data flows, the packet data flows being controlled such that data output from the buffer is dependent upon the quality of service level for the packet data flow concerned.

10. A network as claimed in claim 7, wherein the packet data flows are packet data flow contexts.

11. A network as claimed in claim 10, wherein the packet data flow for a base station is a BVCI connection.

12. A network as claimed in claim 7, wherein the network is a GPRS network.

13. A base station apparatus for use in a telecommunications network, the base station apparatus including a data flow control unit which is operable to control packet data flow communication with a mobile station by controlling the data flow rates of packet data flows associated with the mobile station concerned.
